(19) United States
(12) Patent Application Publication
(10) Pub. No.: US 2012/0178052 A1
(43) Pub. Date: Jul. 12, 2012

(54) STRUCTURE OF ARTIFICIAL TOOTH

(76) Inventor: TAI-WU LIN, Taipei City (TW)

(21) Appl. No.: 13/104,941

(22) Filed: May 10, 2011

(30) Foreign Application Priority Data
Jan. 10, 2011 (TW) 100200457

(51) Int. Cl. A61C 5/11

(52) U.S. Cl. 433/220

(57) ABSTRACT

An artificial tooth includes an internal crown member and an external crown member. The internal crown member includes a recess and a peg. The recess is formed in a top surface of the internal crown member. The peg is formed in the recess. The peg has a top end forming a retention block. The external crown member forms a resilient cap. The resilient cap is formed at a location corresponding to the retention block and can be fit over the retention block to form clamping engagement therebetween. When the external crown member is fit over the internal crown member, the resilient cap encloses and clamps the retention block.

### (A) TECHNICAL FIELD OF THE INVENTION

The present invention generally relates to an artificial tooth that comprises internal crown and external crown fit to each other, and more particularly to an artificial tooth that comprises internal and external crowns between which mateable ball and socket retention structures is formed.

### (B) DESCRIPTION OF THE PRIOR ART

When a tooth is damaged, such as being corroded or forming a large cavity, mastication function of the tooth is impaired. An artificial crown is commonly used to maintain or restore the normal function of mastication. Further, a main stream of artificial tooth is a prosthetic device formed of a combination of internal and external crown members, which effectively restores the mastication function of the damaged tooth and can be removed for completely cleaning the circumference of the tooth neck.

Such a removable artificial tooth is structured by cementing an internal crown member to an abutment tooth and then fitting an external crown member to the internal crown. The frictional force induced between the internal and external crown members fixes them together. This was the design of the original German manufacturer. The external crown can be removed for throughout cleaning. This type of dual-crown artificial tooth is one of the most commonly used prosthetic devices. However, such an artificial tooth suffers poor mechanical stability between the mutually-fit internal and external crowns. Since the external crown and the internal crown are fixed together by frictional force, when the frictional force is insufficient, the external crown may be unexpectedly detached due to chewing food, especially sticky food stuffs. On the other hand, when the frictional force between the internal and external crowns is excessive, the removal of the external crown becomes extremely difficult or even impossible.

### SUMMARY OF THE INVENTION

The present invention aims to overcome such a problem by making moderate tightness between the internal and external crowns so as to allow easy and efficient removal of the external crown and eliminate any potential problems caused by under- or over-tight engagement between the crowns and thereby being good for use by general dental patients.

The present invention provides an artificial tooth, which comprises an internal crown member and an external crown member. The internal crown member comprises a recess and a peg. The recess is formed in a top surface of the internal crown member. The peg is formed in the recess. The peg has a top end forming a retention block. The external crown member forms a resilient cap. The resilient cap is formed at a location corresponding to the retention block and can be fit over the retention block to form clamping engagement therebetween. When the external crown member is fit over the internal crown member, the resilient cap encloses and clamps the retention block.

Through the mutually engageable arrangement between the resilient cap and the retention block according to the present invention, a user may use the device easily. Since the engagement is not just realized through frictional force between the internal and external crown members, there will be no such problems of being hard to remove the external crown member due to excessive tightness, or unexpected removal due to chewing sticky foodstuffs or incorrect positioning in installing the device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an embodiment according to the present invention.

FIG. 2 is a perspective view of an internal crown member according to the present invention.

FIG. 3 is a perspective view of an external crown member according to the present invention.

FIG. 4 is a perspective view demonstrating coupling between the external crown member and the resilient cap according to the present invention.

FIG. 5 is a cross-sectional view of the present invention.

FIG. 6 is a perspective view showing an internal crown member according to the present invention, wherein a retention block is of a spherical form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

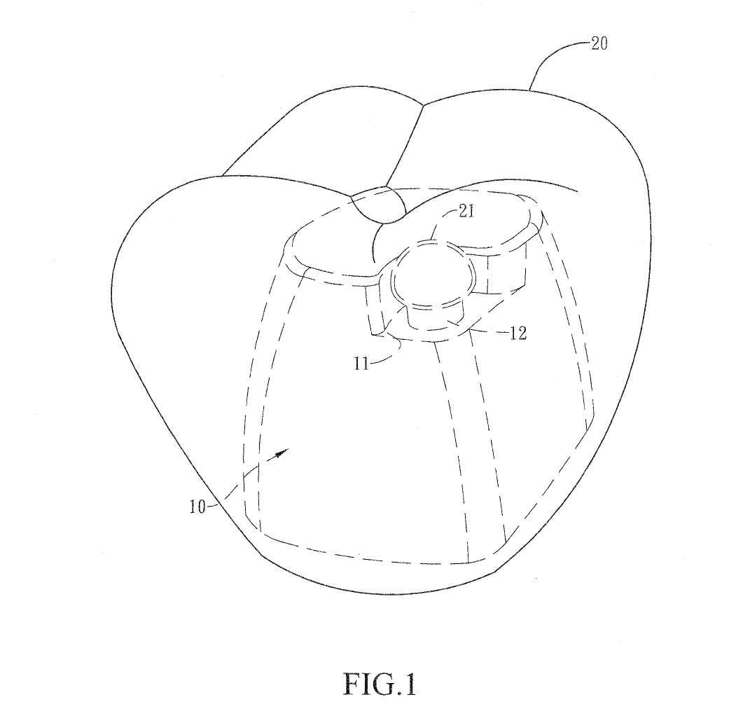

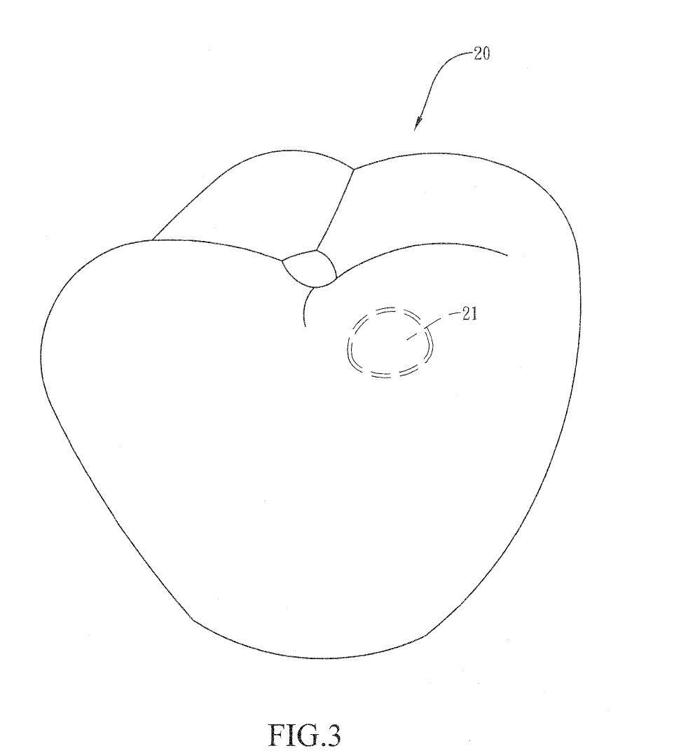

Referring to FIGS. 1-5, an artificial tooth constructed according to an embodiment of the present invention comprises an internal crown member 10 and an external crown member 20. The internal crown member 10 forms a recess 11 and a peg 12. The recess 11 is formed in a top surface of the internal crown member. The peg 12 is formed in the recess 11. The peg 12 has a top end forming a retention block 121. The external crown member 20 forms therein a resilient cap 21, and the resilient cap 21 is set at a location corresponding to the retention block 121 to be fit to the retention block 121 to form clamping engagement therebetween. When the external crown member 20 is fit over the internal crown member 10, the resilient cap 21 encloses and clamps the retention block 121.

The resilient cap 21 provides a resiliency for stably clamping the retention block 121, whereby when the external crown member 20 is pushed toward the internal crown member 10, the resilient cap 21 is fit over and encloses the retention block 121 to realize stable engagement between the external crown member 20 and the internal crown member 10. To remove the external crown member 20, the external crown member 20 is simply lifted upward to separate the resilient cap 21 from the retention block 121 and then the external crown member 20 is removed. Installation of the artificial tooth by means of the mutually engageable arrangement between the resilient cap 21 and the retention block 121, rather than simply counting on the frictional force induced between the internal crown member 10 and the external crown member 20, helps overcoming the problems of excessive tightness, which leads to difficult removal or installation, and being easy to remove by sticky foodstuffs.

Further, the retention block 121 and the peg 12 may form therebetween a retention groove 13, which assists securely mounting of the resilient cap 21. When the resilient cap 21 is fit to the retention block 121, a circumference of an opening of the resilient cap 21 is fit into the retention groove 13 to improve the engagement stability between the resilient cap 21 and the retention block 121 so as to more securely hold the external crown member 20 in position against detachment.

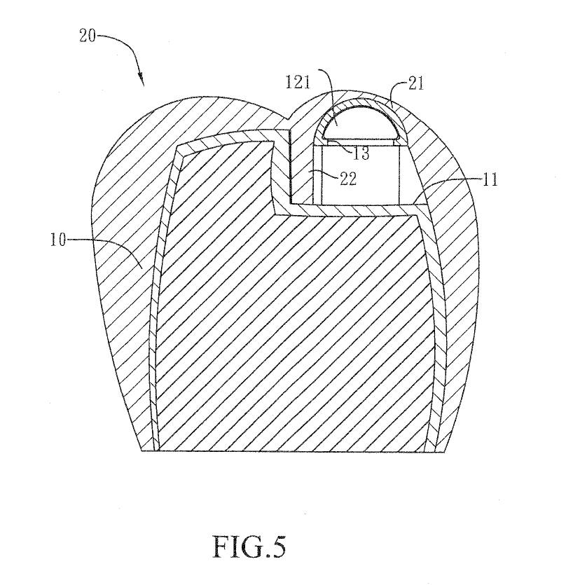

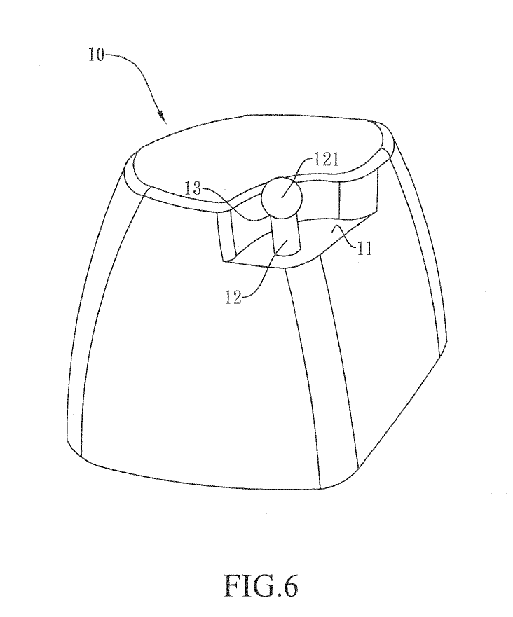

The retention block 121 can be made in a curved form as shown in FIG. 5, or a spherical or ball form as shown in FIG. 6. The spherical retention block 121 and the peg 12 forms a retention groove 13 due to the difference of diameters of the two so that the resilient cap 21 can be put, from the upper side of the retention block 121 to the lower side, to fit over the retention block 121. It is apparent that the resilient cap 21 must be sized and shaped according to the configuration of the retention block 121. Further, to improve the engagement between the resilient cap 21 and the retention block 121, the diameter of the opening of the resilient cap 21 can be made smaller than an outside diameter of the retention block 121 so as to ensure tight engagement between the resilient cap 21 and the retention block 121. It is certain that the retention block 121 can be of other configurations that are not shown herein and those are considered equivalents of the retention block 121.

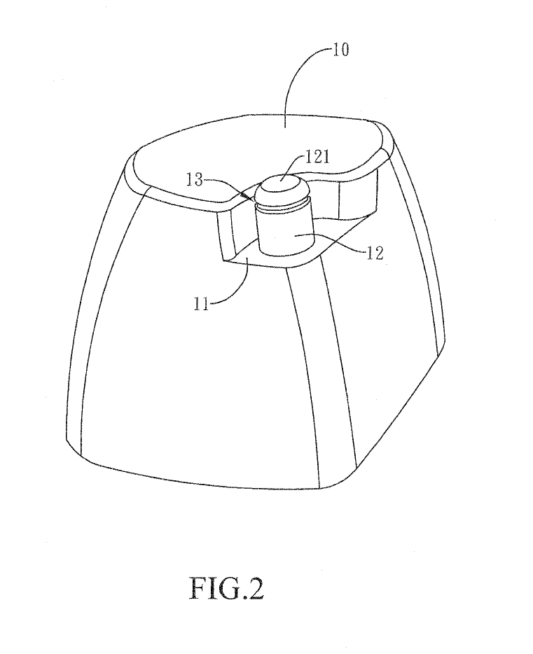

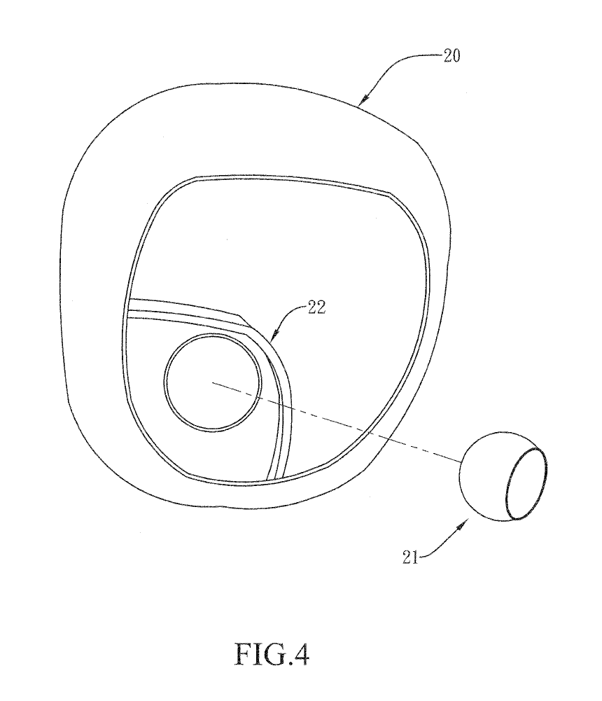

Further, as shown in FIG. 2, the recess 11 is formed at an edge of the top surface of the internal crown member 10. This facilitates the convenience of operation. Also referring to FIGS. 4 and 5, in an embodiment of the present invention, the external crown member 20 forms therein a coupling wall 22, which is formed to correspond to the resilient cap 21 in order to serve as a wall to which the resilient cap 21 can be bonded, whereby the resilient cap 21 is more securely mounted inside the external crown member 20 to endure repeated removal and insertion without being easily detached from the external crown member 20.

Further, the resilient cap 21 can be made of a rubber material and formed as a bowl like shape to correspond the configuration of the retention block 121, thereby providing excellent retention force. Alternatively, the retention block 121 is of a spherical shape and the resilient cap 21 is a resilient cap made of a metal plate to correspond in shape to the retention block 121.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An artificial tooth, comprising:
an internal crown member, which comprises:
a recess, which is formed in a top surface of the internal crown member, and
a peg, which is formed in the recess and has a top end forming a retention block; and
an external crown member, which forms therein a resilient cap, the resilient cap being formed at a location corresponding to the retention block, the resilient cap being fit over the retention block to form clamping engagement therebetween;
wherein when the external crown member is fit over the internal crown member, the resilient cap encloses and clamps the retention bloc.

2. The artificial tooth according to claim 1, wherein the retention block and the peg comprises a retention groove formed therebetween.

3. The artificial tooth according to claim 2, wherein the retention block is of a curved shape or a spherical shape.

4. The artificial tooth according to claim 3, wherein the resilient cap has an opening that has a diameter smaller than an outside diameter of the retention block.

5. The artificial tooth according to claim 4, wherein the recess is formed at an edge of the top surface of the internal crown member.

6. The artificial tooth according to claim 5, wherein the external crown member forms a coupling wall therein, the coupling wall being formed to correspond to an outer circumference of the resilient cap.

7. The artificial tooth according to claim 6, wherein the resilient cap is of a bowl shape and is made of a rubber material.

8. The artificial tooth according to claim 6, wherein the retention block is spherical and the resilient cap is a resilient cap made of metal plate.
